(19) United States
(12) Patent Application Publication
(10) Pub. No.: US 2017/0218733 A1
(43) Pub. Date: Aug. 3, 2017

(54) MODEL BASED TESTING OF ROTATING BOREHOLE COMPONENTS

(71) Applicants: Jayesh J. Jain, The Woodlands, TX (US); Mohamed Ichaoui, Braunschweig (DE)

(72) Inventors: Jayesh J. Jain, The Woodlands, TX (US); Mohamed Ichaoui, Braunschweig (DE)

(73) Assignee: Baker Hughes Incorporated, Houston, TX (US)

(21) Appl. No.: 15/010,876

(22) Filed: Jan. 29, 2016

(51) Int. Cl. E21B 43/00; G06F 17/11; E21B 44/02

(52) U.S. Cl. CPC E21B 43/00; E21B 44/02; G06F 17/11

(57) ABSTRACT

A method of testing a downhole component configured to be incorporated in a drilling assembly includes generating a mathematical drilling assembly model representing a connecting string as a virtual connecting string and describing a behavior of the connecting string in response to rotation of the drilling assembly, disposing the downhole component at a sample of a formation material, and rotating the downhole component by applying a torque to the downhole component via a torque motor based on the drilling assembly model and a selected rotational rate of a virtual top drive. The method further includes inputting real time measurements of an angular velocity of the downhole component into the drilling assembly model, calculating a target torque corresponding to an amount of torque that would be applied to the downhole component by the virtual connecting string, and adjusting the applied torque from the torque motor to correspond to the target torque.

### BACKGROUND

Various operations are performed by the energy industry to evaluate earth formations and produce hydrocarbons. Such operations include drilling, stimulation and production. During a drilling operation, a drill string is deployed in an earth formation, which typically includes components such as a drill bit and bottomhole assembly (BHA) components. The proper design of the drill bit and other BHA components is important to ensure efficient and effective drilling and maximize the life of the components. In addition, proper design is important to mitigate deleterious effects including torsional vibrations such as stick-slip and tool face oscillation.

The main cause of torsional vibrations is the relatively thin drill string and the extremely high ratio between length and diameter. Knowledge of the nature of torsional vibrations, and how to prevent their genesis or suppress them, is an important aspect of downhole component design. To facilitate the design of drill bits, BHA components and other downhole components, testing is performed at surface facilities and in field trials. In this direction, there are many types of bits that are developed for different purposes and need to be tested.

### BRIEF SUMMARY

An embodiment of a method of testing a downhole component includes selecting a downhole component to be tested, the downhole component configured to be incorporated in a drilling assembly that includes a connecting string configured to connect the downhole component to a surface location, and generating a mathematical drilling assembly model, the drilling assembly model representing the connecting string as a virtual connecting string and describing a behavior of the connecting string in response to rotation of the drilling assembly by a virtual top drive. The method also includes disposing the downhole component, by a support structure, at a sample of a formation material, and rotating the downhole component by applying a torque to the downhole component via a torque motor based on the drilling assembly model and a selected rotational rate of the virtual top drive. The method further includes, during the rotating, receiving real time measurements of an angular velocity of the downhole component, inputting the angular velocity into the drilling assembly model, and calculating a target torque based on the drilling assembly model, the selected rotational rate of the top drive and the measured angular velocity, the target torque corresponding to an amount of torque that would be applied to the downhole component by the virtual connecting string. The method still further includes adjusting the applied torque from the torque motor to correspond to the target torque, and evaluating performance of the downhole component based on the testing.

An embodiment of a system for testing a downhole component includes a support structure configured to dispose a downhole component at a sample of a formation material, the downhole component configured to be incorporated in a drilling assembly that includes a connecting string configured to connect the downhole component to a surface location, a torque motor operably connected to the downhole component and configured to apply a torque to the downhole component, and a controller configured to control the torque motor to rotate the downhole component based on a mathematical drilling assembly model, the drilling assembly model representing the connecting string as a virtual connecting string and describing a behavior of the virtual connecting string in response to rotation of the drilling assembly by a virtual top drive. The controller is configured to perform: during the rotating, receiving real time measurements of an angular velocity of the downhole component; inputting the angular velocity into the drilling assembly model, and calculating a target torque based on the drilling assembly model, the selected rotational rate of the top drive and the measured angular velocity, the target torque corresponding to an amount of torque that would be applied to the downhole component by the virtual connecting string; and adjusting the applied torque from the torque motor to correspond to the target torque.

### BRIEF DESCRIPTION OF THE DRAWINGS

The following descriptions should not be considered limiting in any way. With reference to the accompanying drawings, like elements are numbered alike:

FIG. 1 depicts an embodiment of a well drilling, production and/or measurement system;

FIG. 2 depicts an embodiment of a testing system configured to operate downhole components and test components under simulated conditions; and

FIG. 3 depicts a visualization of a model of a drilling assembly;

FIG. 4 depicts an example of a control loop used by a controller of the testing system of FIG. 2;

FIG. 5 depicts an example of a control loop used by a controller of the testing system of FIG. 2;

FIG. 6 depicts aspects of drilling assembly behavior associated with a stick-slip condition;

FIG. 7 is a flow chart providing an exemplary method of testing one or more downhole components;

FIG. 8 depicts an example of a control loop used by a controller of the testing system of FIG. 2 for simulation of axial forces and/or vibrations.

### DETAILED DESCRIPTION

Systems, apparatuses and methods are described herein for testing the performance and characteristics of downhole components, such as drill bits and bottomhole assemblies (BHAs), which are configured to be disposed downhole in an earth formation. Embodiments of a testing system and method simulate real world drilling conditions and perform testing of one or more downhole components by drilling into a formation sample material using the downhole components, and incorporate control of the physical downhole components according to a mathematical model of a downhole assembly or system. A “downhole component” is any component, object or device that is configured to be disposed in a borehole in an earth formation during a drilling, stimulation, production, measurement or other energy industry operation. For an actual field operation, the downhole component is connected to other components of a drilling or production system, such as a drill string or production string, a top drive or other motor (e.g., a mud motor), and surface equipment such as controllers, processors, pumps, fluid sources and others. In order to evaluate a downhole component (e.g., a drill bit and/or BHA), the actual physical component is operated on the sample according to a mathematical model that simulates other components of the drilling or production system. Thus, a full drilling or production system can be simulated without having to physically reproduce the entire system, while allowing the downhole component to physically interact with the sample. In this way, complex interactions between the downhole component and the sample and behaviors (e.g., stick-slip) due to such interaction are allowed to naturally evolve during operation, eliminating the need to attempt to directly model or prescribe such interactions and behaviors.

The model includes a description of characteristics of physical components to be tested in combination with simulation of additional components, such as a connecting string (e.g., an assembly of drill pipes or length of coiled tubing) that connects the physical components to a drilling rig or other surface location, and simulation of conditions above the physical components that would affect the amount of torque experienced by the physical components. The model is used to estimate torsional and/or axial forces that would be applied by an actual connecting string during drilling without physically recreating the connecting string. The estimated torsional forces from the connecting string and/or other simulated components (“virtual components”) may be applied to the physical components during testing by applying torque to the physical components via a motor (referred to herein as a “torque motor”). In addition, axial forces exerted on the physical components by the virtual connecting string and/or other virtual components may be estimated and applied by a suitable actuator during testing.

The systems and methods provide means for testing downhole components and recreating low frequency torsional vibrations such as stick-slip and tool face oscillations to inform planning of drilling operations and design of the downhole components. For example, the torque motor is controlled to rotate the downhole components and apply torque to the downhole components, which simulates torsional forces applied by the connecting string during steady state conditions and/or during stick-slip conditions.

In one embodiment, a testing system includes a controller or processor that applies a torque to physical downhole components (e.g., a drill bit, a drill collar and/or other BHA components) that are being tested so that the overall or total torque applied to the downhole components corresponds to the equation of motion of a complete drilling system that includes the drill bit, BHA and the connecting string. Effectively, the torque motor mimics the behavior of virtual components above the physical downhole components by calculating and delivering an appropriate amount of torque that would be applied by the virtual components in response to reactive torque at the bit. The torque motor is used to control the applied torque instead of directly controlling the rotational rate (RPM) of the downhole components. In this way, the downhole component RPM can be allowed to evolve naturally in response to actual interactions with formation material and simulated forces from the connecting assembly. It is noted that existing laboratory setups can be modified through torque motor control to reproduce realistic drill string behavior.

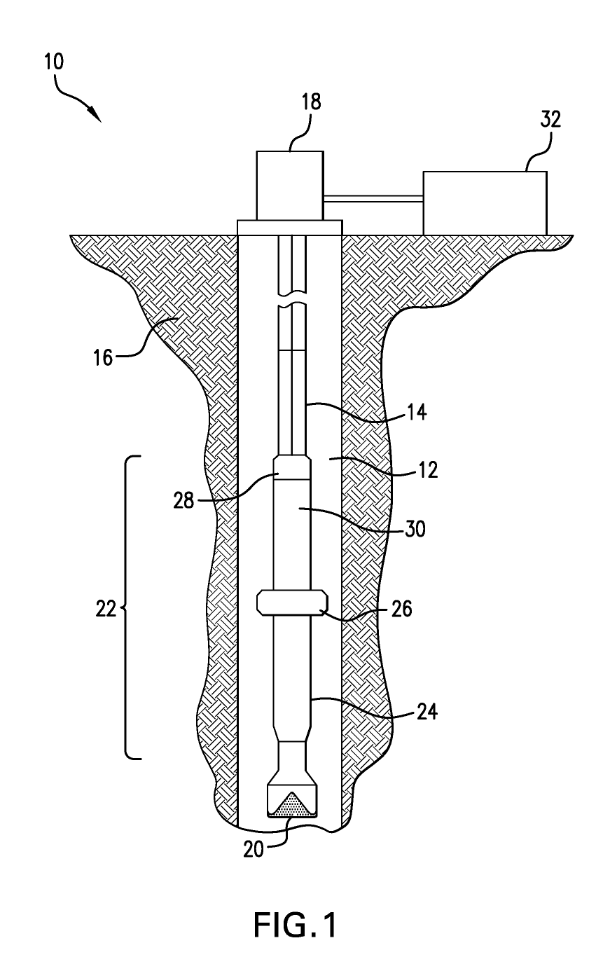

FIG. 1 illustrates an example of a system 10 that can be used to perform one or more energy industry operations, and retrieve and utilize procedural information described herein. The system 10 in this example is a drilling, well logging and/or production system that includes a borehole string, shown in this embodiment as a drill string 14, disposed in a borehole 12 that penetrates at least one earth formation 16. Although the borehole 12 is shown in FIG. 1 to be of constant diameter, the borehole is not so limited. For example, the borehole 12 may be of varying diameter and/or direction (e.g., azimuth and inclination). The drill string 14 is made from, for example, a pipe, multiple pipe sections or coiled tubing. The drill string 14 connects various downhole components to surface equipment at a wellhead or drilling rig 18. Downhole components include a drill bit 20 and various components that may be incorporated as a bottomhole assembly (BHA) 22. The BHA 22 includes, for example, a drill collar 24, one or more stabilizers 26, and a connection sub 28 to connect the BHA 22 to the drill string 14. Other components that may be incorporated into the BHA include measurement devices or sensors such as a logging-while-drilling (LWD) tool 30, a telemetry unit, power supplies, a downhole drilling motor, a directional control device, a measurement-while-drilling (MWD) tool, and others.

In this embodiment, the drill string 14 is rotated by a driving device, such as a top drive or rotary table, which drives the drill bit 20. Downhole drilling fluid, such as drilling mud, is pumped into the drillstring 14 and returns to the surface through the borehole 12. Although the driving device is described in this embodiment as a surface device, it is not so limited. For example, the drill bit 20 can be driven by a downhole driver such as a mud motor or positive displacement motor.

The system 10 and BHA 22 is not limited to the configuration shown in FIG. 1, and may include any devices or components to accomplish or facilitate various energy industry operations, such as drilling, stimulation, production and measurement operations. For example, the system 10 is used to drill boreholes in the formation 16, and may also perform measurements using, e.g., the LWD tool 30. Other types of operations may also be performed, such as production and stimulation operations that include pumping fluid into and/or from the borehole 12 to facilitate production of hydrocarbons from a formation and/or hydraulically stimulate or fracture a formation. Exemplary logging tools include devices implementing resistivity, nuclear magnetic resonance, acoustic, seismic and other such technologies.

A processing unit 40 is connected in operable communication with components of the system 10 and may be located, for example, at a surface location. The processing unit 40 may also be incorporated with the drill string 14 or the BHA 18, or otherwise disposed downhole as desired. The processing unit 40 may be configured to perform functions such as controlling drilling and steering, transmitting and receiving data, processing measurement data and/or monitoring operations.

The main process during production of oil and gas is the drilling of boreholes or wells, which includes the rotation of a drill string supported with a bit to drill through rocks. The bit is driven by a driver such as a top drive (e.g., during rotary drilling) or downhole driver (e.g., during directional drilling). Due to the rotation and the high weight of the drill string, the rock can be crushed by the bit. However, during this cutting mechanism many types of vibrations happen. These vibrations are mainly lateral, axial and torsional vibrations, and can be an important cause of premature failure of the bit, and are the major cause of the energy losses during drilling.

The main cause of torsional vibrations is the relatively thin drill string and the extremely high ratio between the length and diameter of the drill string as the drill bit advances through a formation. One type of torsional vibration occurs due to stick-slip phenomena, which commonly occur during drilling and reduce drilling energy and performance extensively, and can be potentially destructive. Stick-slip is characterized by two phases which occur periodically, referred to as the stick and slip phases. During the stick phase, the angular velocity of the bit is equal to zero which means that the bit is sticking while the torque on the bit is increasing. When this torque exceeds a certain limit, the slip phase begins, which is characterized by an increasing RPM of the bit which can even reach double or more of the top drive angular velocity. Low frequency torsional vibrations such as stick-slip and tool face oscillations are important phenomena that should be taken into account when planning drilling processes and designing drill bits and other downhole components.

Embodiments described herein provide approaches for testing downhole components, which incorporate both mathematical modeling and physical testing to simulate realistic drill string behavior in full scale laboratory testing. The embodiments may be used to evaluate and design drill bits and other components, and provide effective means to accurately simulate drilling processes and subject tested components to various conditions that could be encountered during drilling, such as axial vibrations and torsional vibrations. The embodiments facilitate design of components and evaluation of drilling techniques to reduce or minimize these kinds of vibrations in order to make drill strings more stable.

Embodiments describe herein include systems and methods for drilling formation material in a testing environment using actual physical downhole components of a drilling system, such as drill bits and/or BHA components, in combination with model-based control to simulate the effect of a drill string or other connecting string on the downhole components. As described herein, a “connecting string” is an assembly of components that connect the physical downhole components to a surface location. Embodiments are described in conjunction with a drill string (e.g., drill pipes or coiled tubing), however the drill string is only an example of a connecting string. In addition, although embodiments are described in the context of a drilling system, the embodiments can be applicable to any energy industry system that has rotating components.

Control of drilling is based on a model or equation of motion of a complete drilling system that incorporates the physical components and a mathematical model of virtual components such as a virtual connecting string. Based on the model, drilling is controlled during a test by adjusting the torque applied to the downhole components such that the total torque incident on the components represents the equation of motion of the whole drilling system including the drill string. In this way, the compliance, inertia, and damping of the connecting string can be effectively represented without requiring a physical recreation or physical analogue in the testing system. Realistic drill string behavior such as stick-slip, tool face oscillation, and the effect of low versus high frequency excitation at the bit, can be effectively reproduced in the laboratory.

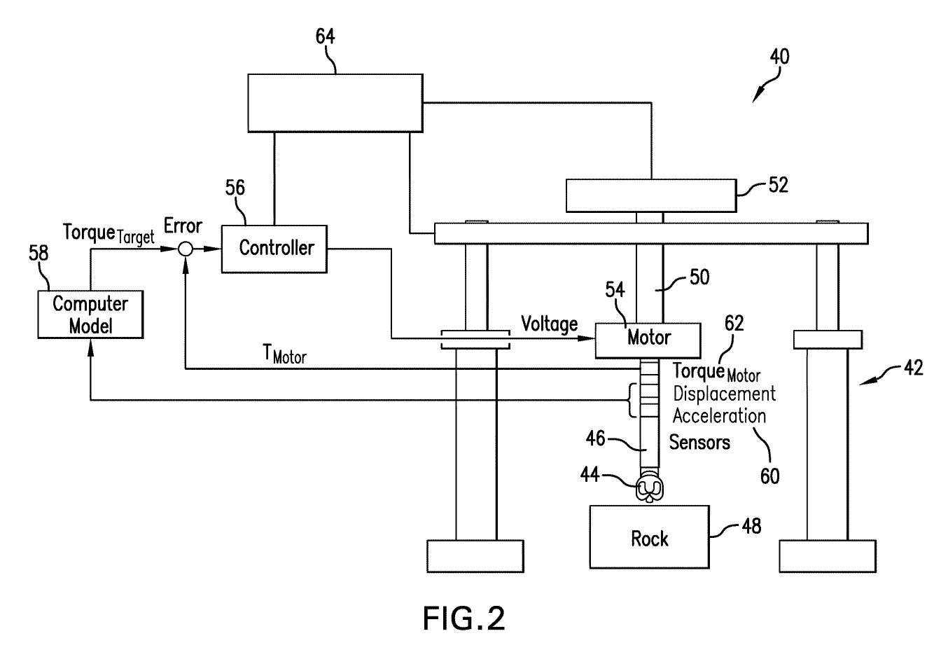

FIG. 2 illustrates aspects of an example of a testing device or system 40 that allows for the simulation of drilling conditions, including torsional and other vibrations. The device or system is well suited for laboratory or surface testing, as it is effective at simulating forces in a drill bit and/or BHA imposed by a drill string, without requiring physical reproduction of the drill string. The device or system can thus be used effectively in surface testing facilities to test components prior to using or testing such components in the field.

The system 40 includes a rig or other support structure 42 that supports one or more physical components of interest. The physical components may include any device or system that is configured to be deployed in a borehole. The physical components, when employed in the field, are connected to the surface and/or controlled via a drill string, borehole string (e.g., coiled tubing) or other assembly, which is referred to herein as a “connecting string”. Other components, such as a top drive or mud motor and surface equipment are connected to the connecting string and used to control drilling parameters. The connecting string and other components are not physically incorporated into the system 40, but are rather simulated using a mathematical model of the string as discussed further below. The physical components, in one embodiment, include a drill bit 44 and optional attached components 46 such as one or more BHA components. For example, the attached components include a BHA made of steel shafts and drill collars. As described herein, the one or more physical components to be tested are referred to as a bottomhole simulator (BHS) assembly. The “BHS assembly” refers to physical components that are to be operated and deployed at a sample of formation material such as a rock sample 48.

The support structure 42 is configured to position the BHS assembly (e.g., a drill bit and BHA components) at the rock sample 48. The rock sample 48 may be an actual sample of rock in a formation expected to be encountered, or any rock or other material selected to approximate or correspond to actual formation materials expected to be drilled by the drill bit 44. In the embodiment shown in FIG. 2, the sample 48 is a volume of a material located at a test facility, but is not so limited. For example, the system can be configured to drill and simulate drilling conditions in formation or rock material at a field location.

The system 40 also includes a motor 54 to rotate the drill bit 44 and/or BHA components 46 and control an amount of torque that is applied to the drill bit 44 and/or the BHA components 46. A circulation system may be provided to circulate fluid through the BHA assembly and the drilled borehole to simulate fluid flow and downhole pressure conditions. The system 40 may also include an axial force application device such as a hydraulic ram or piston 50 configured to apply a selected weight on bit (WOB) and controllable by a controller 52, such as a Proportional Integral (PI) controller. The system 40 is able to physically recreate the interaction between the downhole components and the rock sample 48, as well as the rotational force generated by a simulated drill string and a simulated drilling motor, and the weight of the a full drilling system.

The system 40 also includes a torque control system that includes the motor 54 (described herein as a “torque motor”) that is configured to apply a torque representative of a virtual connecting string and other virtual components. In one embodiment, the torque motor 54 is a high torque direct current (DC) motor that is operatively connected to the BHA assembly and configured to apply torque based on a model of the drilling assembly. Effectively, the torque motor 54 mimics the behavior of components that would be disposed above the BHA assembly as part of a drilling system, by calculating and delivering an appropriate amount of torque in response to the reactive torque at the bit. The “reactive torque” is an amount of torque generated by the drill bit and/or BHA assembly in response to the applied weight-on-bit (WOB) and acts in a direction that is opposite to the direction of the applied torque.

Thus, the downhole component is controlled by the torque motor 54 to drill into the sample 48, and is also controlled to simulate forces applied by the connecting string due to, e.g., low frequency torsional vibrations of the connecting string. Thus, the torque motor 54 replaces all components and features of a drilling system that are not physically reproduced in the system 40 and would be used in the field (e.g., a top drive, a connecting string, surface controls, borehole interactions with downhole components, etc.), while also simulating the forces that would be applied by the top drive and the forces that would be imposed by the connecting string.

A processor or processing device such as a controller 56 (e.g., a PI controller) is coupled to the torque motor 54 and is configured to control the motor based on a mathematical model 58 of the drilling system, which incorporates characteristics of the physical components (in this embodiment the drill bit 44 and the BHA components 46), mathematically represents the connecting string as a virtual connecting string, and simulates behavior of the connecting string, forces on the connecting string (e.g., by a simulated top drive) and forces and torques applied to the physical components by the connecting string. The controller 56 calculates an amount of torque that would be applied by the connecting string, and applies the calculated amount of torque to the physical components.

Various sensors are disposed at or otherwise connected to the downhole components being tested, to measure parameters such as displacement (movement along the drilled borehole), angular deflection, angular movement and torque. Sensors 60, including displacement and/or acceleration sensors, provide measurement signals to the controller 56, which inputs the signals to the model 58. The model 58 and the measurement signals are used to estimate the amount of torque that would be applied by the connecting string, and apply a torque to the drill bit and other downhole components. The system 40 also includes a torque sensor 62 connected to the torque motor 54 to measure the amount of torque being applied by the torque motor 54, which is used as a feedback in a control loop to control the motor 54 and maintain the applied torque to values calculated using the model 58.

The controller 56 and/or the controller 52 may be connected to or incorporated in a processing unit 64 that controls aspects of the system 40 and associated methods. The processing unit 64 may be configured to perform functions such as controlling operation of the torque motor 54, the hydraulic piston 50, and other parts of the system such as fluid control systems. In addition to control functions, the processing unit 64 may perform various functions for data collection and analysis, and evaluation of test results. The processing unit 64 includes a processor and a data storage device (or a computer-readable medium) for storing, data, models and/or computer programs or software.

The system 40 provides the ability to reproduce real drilling conditions in laboratory conditions, while providing the ability to examine the progress of a bit being drilled after relatively small depth changes, and also providing the ability to examine a drilled hole. This is in contrast to typical field testing, which does not allow for direct examination of a drilled hole, and also makes it difficult to examine the progress of a bit after small depth intervals. Examination of the hole is important for analyzing and understanding the behavior of drill bits. For example, considering the hole can lead to the identification of the type of vibrations such as the bit whirl. Another important capability of the system 40 is the ability to reproduce bit-rock interaction with full size bits while being able to accurately simulate interactions between components of an entire drilling assembly or system in a laboratory setting without requiring physical reproduction of the entire assembly or system.

The mathematical model 58 simulates the behavior of a connecting string that is expected or planned to be used with the drill bit 44 and/or BHA components 46. The model 58 receives inputs such as the rotational speed or angular velocity “Ω” of a virtual or fictitious top drive and the WOB to calculate an amount of torque that would be applied by a connecting string during drilling. Based on this model, the system 40 applies a torque to the drill bit that is representative of the torque that would be applied by the connecting string, e.g., as a result of rotating the connecting string and/or interactions of the connecting string with a borehole wall, borehole fluids and/or formation materials.

In the model 58, the virtual top drive or other drilling motor rotates with an angular velocity, which is typically considered to be a constant angular velocity “Ω₀”, but is not so limited. During drilling, the BHS assembly usually rotates with a different angular velocity than Ω₀, due to simulated conditions such as interaction with rock and forces applied by the BHA and the virtual connecting string. Parameters during drilling that can be measured or simulated include the weight on bit (“WOB”), the torque on bit (“TOB”), the hookload (“H₀”), the angular deflection “φ” of the BHS assembly and the angular velocity (φ) of the BHS assembly in radians per second or in revolution per minute (RPM).

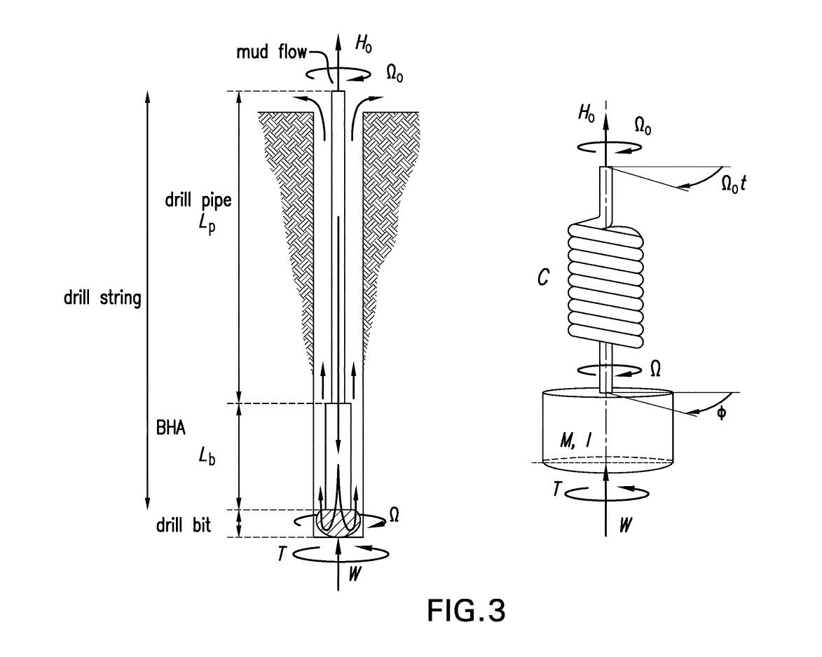

In one embodiment, the connecting string is modeled as a torsional oscillator as shown in FIG. 3. Because of the high ratio of length to diameter of the drill string, the connecting string twists elastically in a similar manner to a torsional spring, and thus can be modeled as a spring system “C”. The drill bit and/or BHA is the stiffest part of the downhole system due to its relatively short length and high diameter, and thus can be modeled as a rigid rotating mass “M”. Thus, the entire drilling assembly model can be simplified to a simple torsional oscillator as shown in FIG. 3. In this case, the inertia of the system can be approximated to the inertia of the rigid rotating mass M and the stiffness “k” of the spring system C can be approximated to the stiffness of the connecting string, which are shown as drill pipes in this embodiment. For example, the BHA including drill collars, stabilizers and potentially downhole measurement tools are considered as a single mass M having an inertia “I”.

The torque motor (e.g., the motor 54) can be controlled using an equation of motion of the simplified drill string model shown in FIG. 3, which can be represented by the following:

I\ddot{φ}+k(φ−Ω₀t)=−T, (1)

where “T” is the overall torque applied to the BHS assembly due to rotation and deformation of the connecting string, “I” is the inertia of the BHS assembly, and “k” is a stiffness constant calculated based on characteristics of the connecting string that is being simulated. “φ” is the angular deflection of the BHS assembly “\ddot{φ}” is the angular acceleration of the BHS assembly, “t” is time, and “Ω₀” is the angular velocity of the top drive. The equation of motion, in one embodiment, ignores damping effects for the sake of simplicity. However, the equation of motion and the model can include damping as well.

By replacing a physical connecting string with a torque motor, the component of the torque attributed to the connecting string, which is represented as “k(φ−Ω₀t” in equation (1) can be replaced with the amount of torque applied by the motor, which is referred to herein as the torque of the motor or “T_{Motor}”. The equation of motion of the BHS assembly can then be represented by:

I\ddot{φ}−T_{Motor}=−T, (2)

where “T_{Motor}” is the torque applied to the BHS assembly by the motor.

Comparison between equations (1) and (2) shows the following: if the generated torque of the motor (T_{Motor}) is equal to the generated torque on the top of the BHS assembly (k(φ−Ω₀t)), then the overall torque due to the drill pipe and the BHS assembly can be effectively recreated by applying the torque due to a virtual connecting string using the torque motor, and applying resisting torque due to the inertia of the BHA and/or drill bit (I\ddot{φ}) using an actual physical assembly.

In some cases, the BHS assembly alone may not posses the amount of inertia of a full scale BHA, thus the inertia of the BHS assembly may be increased using a mechanical means such as adding an inertial mass or using a gear system. Stick-slip happens when the connecting string and/or drilling assembly is vibrating in its first natural frequency. In order to reproduce this phenomenon in the BHS assembly, it is important that the BHS assembly, along with the virtual model, should exhibit the same first natural frequency as the full-scaled drill string.

The formula of the frequency “f” of a simple oscillator system can be represented by:

$$f = \frac{1}{2 π} \sqrt{\frac{Stiffness}{Inertia}} . \qquad ( 3 )$$

In the case of adding a rotating mass, the whole inertia of the system can be expressed as:

I_{Sim,new}=I_{Sim}+I_{Mass}, (4)

where “I_{Sim, new}” is the total inertia of the system, “I_{Sim}” is the inertia of the BHS assembly, and “I_{Mass}^{”} is the inertia of an additional mass added to the BHS assembly in addition to the drill bit and/or BHA components.

In addition to, or in place of, an added mass, a gear system can be incorporated to control the inertia of the BHS assembly. In the BHS assembly rotating through a gear system, the inertia can be written as:

I_{Sim,new}=I_{Sim}+n²I_{Mass}, (5)

where “n” is the gear ratio. A gear system may be advantageous in instances where adding a mass may increase the BHS assembly volume to an unmanageable amount.

In some cases, the mass and number of components used in the BHS assembly is less than the total mass and/or number of components that are expected to be in a full BHA. For example, the BHS assembly includes a drill bit and drill collars, but may not also include components such as LWD tools and additional subs. The following is an example of a calculation of the total amount of inertia needed to physically recreate the inertia and interaction of the full BHA with formation material.

For example, the inertia “I” of a drill string can be approximated as the sum of the mass moment of inertia of all of the components of a full BHA, including a drill collar and BHA components:

$$I = {\sum }_{BHA + D C} I = {\sum }_{BHA + D C} \frac{ρ π L}{32} ( {D}_{o}^{4} - {D}_{i}^{4} ) , \qquad ( 6 )$$

where “Dₒ” is the outside diameter of each component, and “Dᵢ” is the inside diameter. As the inertia is equal to the sum of the inertia of individual parts, the difference in inertia between the full BHA and drill bit and the components including in the BHS assembly can be calculated, and a mass can be added or a gear system with an appropriate gear ratio can be used to add the required inertia.

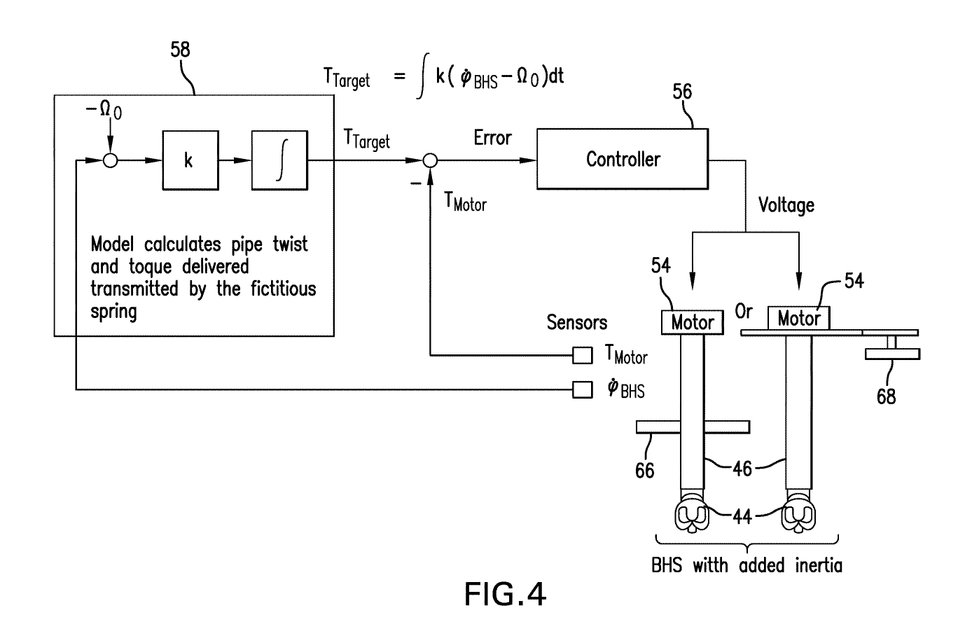

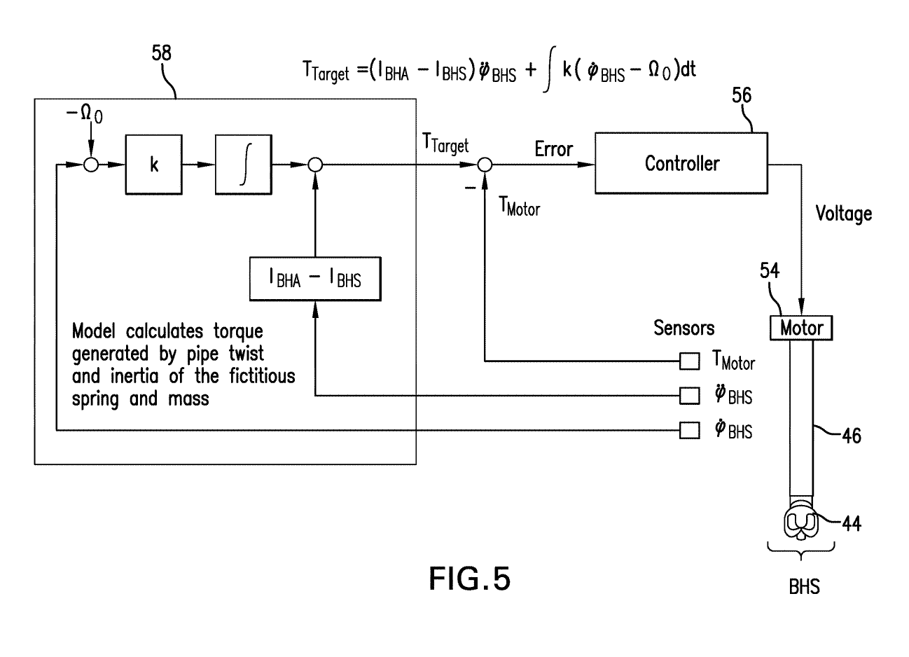

FIGS. 4 and 5 illustrate embodiments of a control loop that may be utilized by the controller 56 (or other suitable processing device) to simulate the torque on a drill bit and/or BHA from a connecting string during drilling. The control loop is used by the controller 56 to receive input data including, e.g., motor torque, angular velocity and/or angular deflection of the BHS assembly. The following equation expresses the set value of the torque motor:

T_{Motor}=k(φ−Ω₀t)=∫k(\dot{φ}−Ω₀)dt. (7)

As shown in FIG. 4, the inertia of the BHS assembly is selected mechanically by adding inertial masses 66 or incorporating a gear system 68 and selecting gear settings. The inertia may be adjusted or controlled to account for additional physical components that are to be employed with the string in the field but are not included in the BHS assembly.

A target value of the motor's torque (“T_{Target}”) is calculated based on equation (1) and inputs including the angular velocity Ω₀ of the (fictitious) top drive and measured angular deflection and/or velocity \dot{φ} of the BHS assembly (\dot{φ}_{BHS}). The model 58 of torque is used to calculate the torque T_{Target} on the BHS assembly due to the connecting string, which is used to control the actual torque of the motor (T_{Motor}). The control loop is used by the controller 56 to manipulate the torque of the motor and keep it equal to T_{Target}. In one embodiment, the controller 56 receives measurements of the motor torque (T_{Motor}), calculates the deviation between T_{Motor} and T_{Target}, and controls the motor 54 to align the motor to the target torque by transmitting a corresponding voltage to the motor.

FIG. 5 illustrates an embodiment of a control loop used to control torque applied by the motor 56 to a BHS assembly that has an inertia that is less than the inertia of a full BHA. In this embodiment, the inertia is not increased mechanically. The equation of motion can thus be represented with the lower inertia of the BHS assembly (I_{BHS}) as follows:

I_{BHS}\ddot{φ}−T_{Motor}=−T, (8)

In this case, the generated torque of the motor 54 should compensate not only for the torque generated due to the deflection in the connecting assembly (e.g., drill pipes), but also the missing part of the resistance torque that would otherwise be added as discussed above.

The torque of the motor 54 may be regulated to match the following target torque that is expressed in the following equation:

T_{Motor}=(I_{BHA}−I_{BHS})\ddot{φ}+∫k(\dot{φ}−Ω₀)dt, (9)

where “I_{BHA}” is the total inertia of a full BHA. In this embodiment, measurements include not only the angular velocity, but also the angular acceleration. Both parameters are used to obtain set points for the target torque.

In one embodiment, the controller 56 is configured to utilize the model 58 to control the motor to apply torque to the BHS assembly during various drilling modes. The model 58 may be used in conjunction with other models or simulations that describe drill bit and/or BHA interaction with rock during selected drilling modes. The model(s) simulate bit-rock interaction to estimate the TOB and the RPM behavior during different drilling modes.

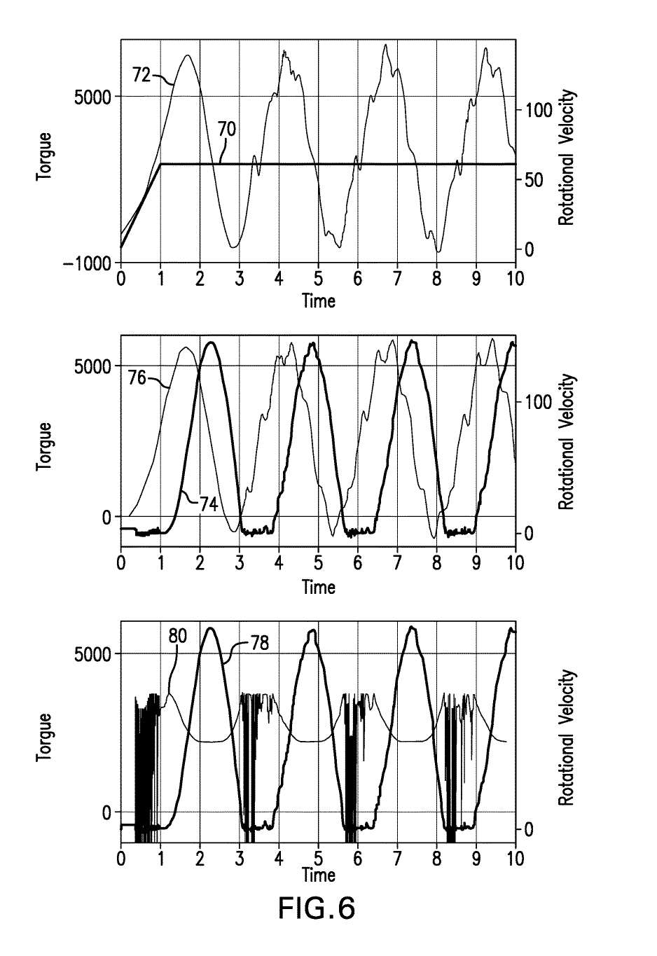

FIG. 6 illustrates an example of behaviors that can be simulated or recreated in conjunction with the mathematical models described herein. In this example, the behaviors are associated with a stick-slip event or events. These behaviors may occur during rotation of physical downhole components in a formation material sample according to embodiments described herein. One advantage of such embodiments is that these behaviors do not need to be directly prescribed, but are rather allowed to naturally develop in response to rotating the downhole components using embodiments of the model described herein.

Curve 70 shows the rotational velocity of a top drive that drives the rotation of a drill bit and drill string, which in this example is kept constant. Curve 72 shows the torque of the top drive as a function of time. Curve 74 shows the rotational velocity and curve 76 shows the torque at a location of the drill string that is between drill pipes and a BHA. Curves 78 and 80 show the rotational velocity and the torque, respectively, experienced by a drill bit and/or the BHA, which illustrate the fluctuations and velocity characteristics of the stick-slip effect.

As shown in FIG. 6, during the stick phase, the bit stops from rotating while the top drive is still rotating, which creates a high deflection in the drill pipes that in turn creates an increasing torque on the top drive. This torque is necessary to raise the input energy in order to transmit it to the bit. An approximately equal amount of torque (if we ignore the damping of the system) is transmitted to the bottom of the drill pipes (which are represented as a spring system in the models described above).

During the slip phase, the bit starts rotating with an increasing RPM. As a result, the deflection in the drill pipes decreases. The torque on the top and bottom of the drill pipes also reduces as the amount of energy needed from the surface is lower. From this described scenario, it is recognized that by inputting a constant rotational velocity on the top drive, we are in fact creating an amount of torque that is transmitted to the BHA.

This amount of torque created as shown in FIG. 6 can be effectively reproduced by predicting the amount of torque that is created on the top of the BHA and regulate the torque of the motor 54 to this predicted value. In other words, the system 40 replaces the drill pipes with a motor that can mimic the behavior of the drill pipes by providing the same amount of torque which is built up due to the drill pipes.

In one embodiment, the torque of the connecting string is simulated using a high-torque DC drilling motor. This is a specialized form of electric motor which can operate even if it is blocked. This means, if the rotor is not rotating, the motor will maintain applying torque without any damage. Another difference between high-torque DC motors and traditional motors is the higher level of torque that it can apply along with their better thermal performance. It is noted that, although embodiments are described in conjunction with a high-torque DC motor, such embodiments can be used with any type of motor capable of applying torque to the BHS assembly in addition to the torque applied by a surface drive or other means to rotate the drill bit and/or BHA.

There are generally two types of high torque motors. A shunt wound motor can provide higher RPM, where a series wound motor can reach higher levels of torque. In both cases, the mechanical power typically ranges between 1000 HP to over 3000 HP. This high amount of energy allows these type of motors to provide the required level of torque to accurately reproduce field conditions.

For motors such as DC motors, the motor 54 may be modeled in order to calibrate or tune the motor to provide for accurate control of the torque generated by the motor. In one embodiment, the DC motor is modeled and controlled based on its functional equation.

A DC motor includes two closed loops: a mechanical loop including a rotating disc, and an electrical loop.

The equation of the electrical loop can be expressed as follows:

Lİ+RI+K\dot{θ}=V. (10)

In the other side of the motor, the mechanical loop is the equation of motion the BHS assembly, which can be written as:

J\ddot{θ}+b\dot{θ}=T−TOB. (11)

In equations (10) and (11), “R” is the electric resistance, “L” is the inductance, “K” is a constant factor, “V” is the voltage, and “I” is the current. “T” is the torque generated by the motor, “θ” is the angle of rotation, “θ” is the angular velocity of a rotating disc in the mechanical side. “J” represents the inertia of the system and “b” represents the damping.

The combination between the two equations is the fact that the generated torque T depends on the electrical flow I:

T=KI (12)

Substituting equation (12) into equation (10) gives:

$$\frac{L}{K} \dot{T} + \frac{R}{K} T + K \dot{θ} = V . \qquad ( 13 )$$

The Laplace transformation of equation (13) leads to:

$$\frac{L}{K} sT + \frac{R}{K} T + K \dot{θ} = V . \qquad ( 14 )$$

Equation (14) can also be written as:

$$T = \frac{K}{Ls + R} ( V - K \dot{θ} ) . \qquad ( 15 )$$

Equation (15) is a linear equation that describes the torque of the excited DC motor as a function of the motor parameters (the motor constant K, the inductance L, and the resistance R) and the inputs which are the voltage V and the angular velocity \dot{θ}.

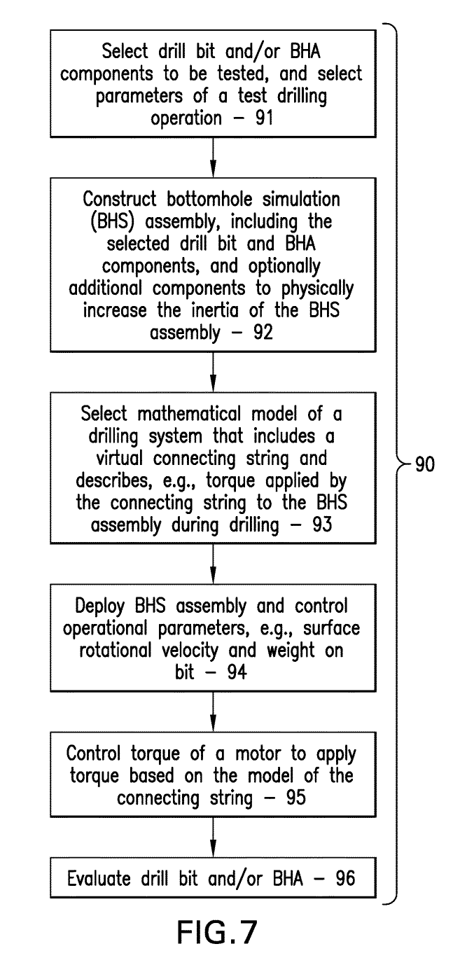

FIG. 7 illustrates a method 90 of testing one or more downhole components. The method 90 is used in conjunction with the system 40, but is not so limited, and can be used with any system capable of performing testing of downhole components as described herein. The method 90 includes one or more stages 91-96. In one embodiment, the method 90 includes the execution of all of stages 91-96 in the order described. However, certain stages may be omitted, stages may be added, or the order of the stages changed.

In the first stage 91, devices, components or systems are selected for testing. In one embodiment, a drill bit is selected having desired characteristics such as size, type (e.g., polycrystalline diamond compact (PDC) bit, impregnated bit, fixed cutter bit, roller cone bit, coring bit, etc.) material construction and others. One or more components of a BHA may also be selected for testing and connected to the drill bit in a configuration that is expected to be employed during drilling. Examples of such components include stabilizers, drill collars, steering components, downhole pumps, downhole motors, measurement tools (e.g., LWD tools) and any other components making up a BHA to be tested. The assembly of physical downhole components to be tested is referred to as a BHS assembly.

In addition, parameters of a connecting string that is to be simulated by a model are selected. Such parameters include physical dimensions (e.g., diameter, ratio of diameter to length), material composition, type (e.g., drill pipes, coiled tubing, etc.), and characteristics such as weight, stiffness and any other desired physical characteristics. These parameters are employed to generate or modify a mathematical model of forces, including torque, imposed on the drill bit and/or BHA by the connecting string.

Operational parameters are also selected. Initial values of operational parameters are selected, such as surface rotational rate and angular velocity (e.g., top drive RPM) and WOB. Other parameters may be selected, such as the type (e.g., drilling mud, stimulation fluid), composition, pressure and flow rate of fluids injected into the rock or borehole during drilling.

In addition, drilling conditions expected to be encountered by the tested components are selected. For example, a material sample is selected through which the drill bit and BHA are to be advanced. The material sample may be a sample of rock taken from a formation or a sample of rock having characteristics similar to those expected to be encounters. Other conditions that could be simulated include fluid content of the material sample and temperature.

It is noted that, although the method 90 is described in the context of drilling, the method 90 can be employed with any type of component that is to be deployed in a borehole.

In the second stage 92, the BHS assembly is constructed by assembling the drill bit, BHA components and other components desired to be included. In one embodiment, if the total mass of the downhole assembly (BHA and/or other components) that would be coupled to the connecting string represents a larger mass than that of the BHS assembly, the BHS assembly alone may not represent the total inertia of the overall downhole assembly. In this embodiment, additional mass or a gear assembly may be attached or operably connected to the BHS assembly to simulate the inertia of the overall downhole assembly.

In the third stage 93, a mathematical model, such as the model 58, is selected that simulates conditions or parameters of the drill bit and/or BHA during drilling due to forces imposed by a connecting string.

In one embodiment, the model is based on the equation of motion discussed above (equations 1 and 2). Using this model and other equations for simulating behaviors, the torque due to the virtual connecting string is applied to simulate various drilling conditions.

In the fourth stage 94, the BHS assembly including the drill bit is deployed at the material sample and drilling is commenced by rotating the BHS assembly by a torque motor to an initial rotational rate. For example, the virtual top drive is ramped up to a constant rotational rate, and the model is used to calculate the behavior of the virtual connecting string (and potentially other virtual components) and the torque that is applied to the BHS assembly as a function of time. Drilling is controlled by controlling operational parameters such as WOB, injected fluid temperature and injected fluid pressure and flow rate.

During drilling, various conditions and/or parameters are monitored as the BHS assembly is operated. For example, sensors disposed with the BHS assembly transmit measurements of conditions continuously or periodically (or according to some selected schedule) to a processor or controller that can be used to evaluate the operation and monitor the operation. Such sensors include, for example, displacement sensors, accelerometers and torque sensors. At least one torque sensor is disposed at or in operable communication with the torque motor in order to control the torque motor using the model.

In the fifth stage 95, the torque applied by the torque motor is controlled to simulate the effect of the connecting string on the BHS assembly. In one embodiment, the torque motor is controlled via a control loop such as the control loop shown in FIG. 4 or FIG. 5.

In one embodiment, a rotational rate of the simulated top drive is controlled as desired, for example, at a constant rate or according to some other function, and input to the model. A processor such as the controller 56 calculates an amount of torque (a target torque) that would be applied to the physical components by the connecting string. This target torque is compared to measurements of the torque actually being applied by the torque motor and the torque motor is modified as needed to keep the applied torque within a selected range or tolerance relative to the target torque. Calculation of the target torque, comparison with measured torque, and adjustment of the torque motor may be performed continuously during the testing or periodically according to selected time intervals.

For example, the control loop continuously (e.g., at each sample time or time that a measurement is received) or periodically receives an angular velocity value from one or more sensors on the BHS assembly. The angular velocity is input to the drilling assembly model to generate a target torque, i.e., the amount of torque that is actually being experienced by the BHS assembly from the torque motor. The target torque is compared to a measured torque taken by a sensor connected to the torque motor, and the torque motor is adjusted to keep the applied torque at or within a selected range of the target torque.

In the sixth stage 96, the operation and/or equipment is evaluated based on the monitoring the determine various characteristics, such as the rate of wear of the drill bit, characteristics of the hole being drilled, and identification of potentially deleterious or otherwise unwanted conditions. For example, the rotational rate over time and/or depth and the progress of torque on the bit or BHS assembly is analyzed to determine whether a stick-slip condition has occurred. In addition, the hole may be inspected to identify the types of vibrations that occur, such as bit whirl. Other evaluations of the drill bit and/or BHS assembly can be performed, such as evaluating the stability of the BHS assembly.

In one embodiment, the bit is operated and advanced a small depth, after which the state of the drill bit and/or other BHA components is examined. In addition, the state of the hole drilled through the sample rock may also be examined.

Embodiments described herein demonstrate a closed-loop control where the control input is dependent on the system output. This controllability guarantees the ability of the torque motor to attain any arbitrary state in the different behaviors of the connecting string. In practical situations, there is always constrained control input based on the capability of the motor which is a maximal voltage that can be provided. This limitation may prevent the motor's torque from being as close as the set torque. Though, even with the consideration of these constraints, the motor has been found to respond quickly and stably. Thus, embodiments described herein present a very useful approach of torque regulation which meets all criteria of controllability (stability and quick response).

In one embodiment, in addition to torsional control discussed above, the systems and methods described herein can also be used to simulate axial movement of a connecting string using a model of the connecting string. In this embodiment, an axial force application device is included in the system 40 to apply axial forces that would be applied to the BHS assembly. This simulation of axial forces may be performed separate from the torsional simulation or performed in conjunction with torsional vibration. For example, the system 40 could be configured to include both a torque application motor and an axial force application device (e.g., the hydraulically controlled piston 50) to simultaneously simulate both axial and torsional forces applied by the connecting string.

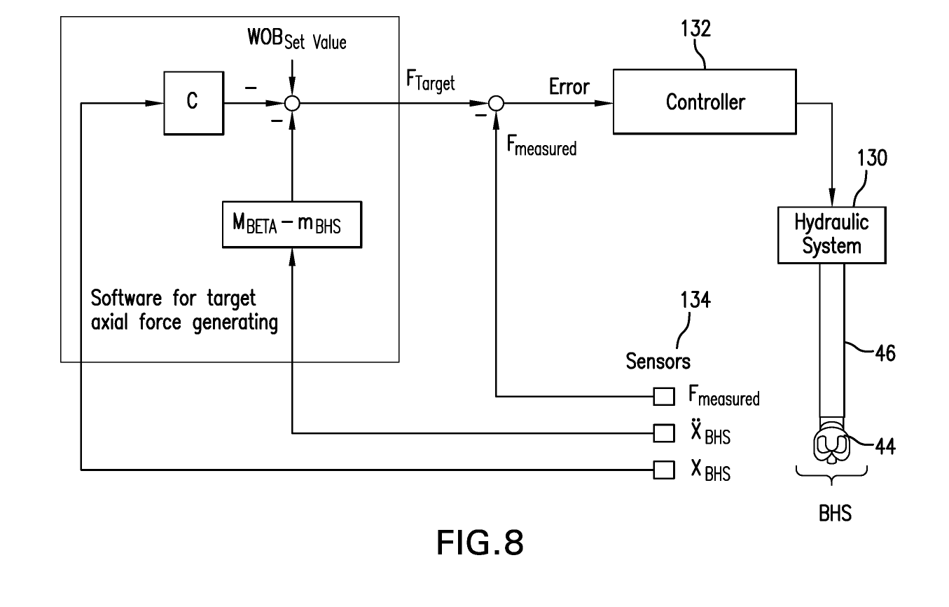

FIG. 8 illustrates an example of a control loop that can be used in conjunction with the testing system 40. In this example, the system 40 includes a controller 102 that receives measurement data from sensors 104 connected to the BHS assembly, and controls an axial force application device 100. The controller 102 may be separate from the torque motor controller 56, or a single controller or processor (e.g., the processing unit 64) can be used to control both the torque motor and the hydraulic system.

The system uses a control loop shown in FIG. 8 to reproduce axial forces applied by the connecting string due to, e.g., axial vibrations that occur during a real drilling operation. As drill pipes have also flexibility (stiffness) in the axial direction, axial vibrations are expected to occur, thus simulation of axial forces simultaneously with the torsional vibrations is useful.

Starting from the equation of motion of the BHS assembly in the axial direction where the damping is disregarded, the WOB can be represented by:

M\ddot{x}+cx=WOB, (17)

where “M” is the vibrating mass of the BHS assembly, “c” is the linear stiffness of the virtual connecting string, “x” is the axial displacement, and “\ddot{x}” is the axial acceleration.

The equation of motion of the BHS assembly supported by a hydraulic system that applies an axial force “F” is expressed as follows:

m_{BHS}\ddot{X}=F, (18)

where “m_{BHS}” is the vibrating mass of the BHS assembly, and “\ddot{x}” is the axial acceleration.

To reproduce the same axial behavior of a full drilling assembly, the generated axial force F compensates the WOB, the stiffness force and the missing force due to the lower mass of the BHS assembly in comparison to a full BHA. More specifically, the hydraulic force can be regulated to equalize:

F=WOB−(M_{BETA}−m_{BHS})\ddot{x}−cx. (19)

It is noted that this control configuration is an example, as various control modalities and models can be used to simulate the axial vibration and force.

One or more aspects of the embodiments described herein can be included in an article of manufacture (e.g., one or more computer program products) having, for instance, computer usable media. The media has therein, for instance, computer readable instructions, program code means or logic (e.g., code, commands, etc.) to provide and facilitate the capabilities of the present invention. The article of manufacture can be included as a part of a computer system or provided separately. These instructions may provide for equipment operation, control, data collection and analysis and other functions deemed relevant by a system designer, owner, user or other such personnel, in addition to the functions described in this disclosure.

The methods and systems described herein provide various advantages over prior art techniques. The embodiments described herein provide for effective testing of components that accounts for downhole behaviors that may not be completely understood and not be amenable to modeling. In addition, testing is performed that accurately simulates downhole conditions and forces due to the entire drill string without requiring field testing. In this way, components can be more effectively designed and testing prior to incurring the additional cost of field testing.

In addition, some prior art techniques calculate displacement at a bit in response to measured bit forces using a transfer function of the drill string, and prescribes or applies displacements as part of a virtual model. In contrast, embodiments described herein use measured displacements and acceleration to calculate the resulting forces and torque from a virtual drill string, which are prescribed to the bit via, e.g., a DC motor. This approach is more accurate, as it more accurately reflects the complex processes at work as the bit interacts with a borehole, and is more easily implemented as it does not require actuators to prescribe the displacements.

In support of the teachings herein, various analyses and/or analytical components may be used, including digital and/or analog systems. The system may have components such as a processor, storage media, memory, input, output, communications link (wired, wireless, pulsed mud, optical or other), user interfaces, software programs, signal processors (digital or analog) and other such components (such as resistors, capacitors, inductors and others) to provide for operation and analyses of the apparatus and methods disclosed herein in any of several manners well-appreciated in the art.

One skilled in the art will recognize that the various components or technologies may provide certain necessary or beneficial functionality or features. Accordingly, these functions and features as may be needed in support of the appended claims and variations thereof, are recognized as being inherently included as a part of the teachings herein and a part of the invention disclosed.

Set forth below are some embodiments of the foregoing disclosure:

### Embodiment 1

A method of testing a downhole component, comprising: selecting a downhole component to be tested, the downhole component configured to be incorporated in a drilling assembly that includes a connecting string configured to connect the downhole component to a surface location; generating a mathematical drilling assembly model, the drilling assembly model representing the connecting string as a virtual connecting string and describing a behavior of the connecting string in response to rotation of the drilling assembly by a virtual top drive; disposing the downhole component, by a support structure, at a sample of a formation material, and rotating the downhole component by applying a torque to the downhole component via a torque motor based on the drilling assembly model and a selected rotational rate of the virtual top drive; during the rotating, receiving real time measurements of an angular velocity of the downhole component; inputting the angular velocity into the drilling assembly model, and calculating a target torque based on the drilling assembly model, the selected rotational rate of the top drive and the measured angular velocity, the target torque corresponding to an amount of torque that would be applied to the downhole component by the virtual connecting string; adjusting the applied torque from the torque motor to correspond to the target torque; and evaluating performance of the downhole component based on the testing.

### Embodiment 2

The method of embodiment 1, wherein the torque motor is configured to apply the applied torque to the downhole component in the absence of a physical structure corresponding to the connecting string.

### Embodiment 3

The method of embodiment 1, wherein the drilling assembly model describes interactions between the virtual connecting string and a borehole during rotation of the virtual connecting string.

### Embodiment 4

The method of embodiment 1, wherein the downhole component is selected from at least one of a drill bit and one or more bottomhole assembly (BHA) components, and the connecting string is a drill string configured to connect the drill bit and the BHA to a surface location during drilling of an earth formation.

### Embodiment 5

The method of embodiment 1, further comprising calculating an axial force that would be applied to the downhole component by the virtual connecting string, and applying an axial force corresponding to the calculated axial force to the downhole component during the rotating.

### Embodiment 6

The method of embodiment 1, wherein the drilling assembly model describes the connecting string as a torsional spring system having a stiffness and the downhole component as a mass having an inertia.

### Embodiment 7

The method of embodiment 6, wherein the drilling assembly model describes the drilling assembly using the following equation of motion:

I\ddot{φ}+k(φ−Ω₀t)=−T,

wherein “T” is an overall torque applied to the downhole component, “I” is the inertia of the downhole component, “k” is a stiffness of the connecting string, “φ” is an angular deflection of the downhole component, “\ddot{φ}” is an angular acceleration of the downhole component, “t” is time, and “Ω₀” is an angular velocity of the driving device.

### Embodiment 8

The method of embodiment 7, wherein controlling includes controlling the torque motor to apply an amount of torque (T_{Motor}) calculated based on a measurement of the angular deflection taken during the rotating, the amount of torque T_{Motor} calculated based on the following equation:

T_{Motor}=k(φ−Ω₀t)=∫k(\dot{φ}−Ω₀)dt.

### Embodiment 9

The method of embodiment 7, wherein the downhole component has a mass that is less than a total mass of a component assembly expected to be connected to the connecting string, and controlling includes controlling the torque motor to apply an amount of torque (T_{Motor}) calculated based on a measurement of the angular deflection and a measurement of the angular acceleration taken during the rotating, the amount of torque T_{Motor} calculated based on the following equation:

T_{Motor}=(I_{BHA}−I_{BHS})\ddot{φ}+∫k(\dot{φ}−Ω₀)dt,

wherein “I_{BHA}” is an inertia of the component assembly calculated based on the total mass, and “I_{BHS}” is an inertia of the downhole component calculated based on the mass of the downhole component.

### Embodiment 10

The method of embodiment 1, wherein applying the torque includes controlling the torque motor using a control loop, the control loop including: receiving measurements of a rotational velocity of the downhole component and calculating a target torque value based on the drilling assembly model and the rotational velocity; measuring an amount of torque generated by the torque motor; and comparing the measured torque to the target torque and adjusting the torque motor so that the measured torque is within a selected range of the target torque.

### Embodiment 11

A system for testing a downhole component, comprising: a support structure configured to dispose a downhole component at a sample of a formation material, the downhole component configured to be incorporated in a drilling assembly that includes a connecting string configured to connect the downhole component to a surface location; a torque motor operably connected to the downhole component and configured to apply a torque to the downhole component; and a controller configured to control the torque motor to rotate the downhole component based on a mathematical drilling assembly model, the drilling assembly model representing the connecting string as a virtual connecting string and describing a behavior of the virtual connecting string in response to rotation of the drilling assembly by a virtual top drive, the controller configured to perform: during the rotating, receiving real time measurements of an angular velocity of the downhole component; inputting the angular velocity into the drilling assembly model, and calculating a target torque based on the drilling assembly model, the selected rotational rate of the top drive and the measured angular velocity, the target torque corresponding to an amount of torque that would be applied to the downhole component by the virtual connecting string; and adjusting the applied torque from the torque motor to correspond to the target torque.

### Embodiment 12

The system of embodiment 11, wherein the torque motor is configured to apply the applied torque to the downhole component in the absence of a physical structure corresponding to the connecting string.

### Embodiment 13

The system of embodiment 11, wherein the drilling assembly model describes interactions between the virtual connecting string and a borehole during rotation of the virtual connecting string.

### Embodiment 14

The system of embodiment 11, wherein the downhole component is selected from at least one of a drill bit and one or more bottomhole assembly (BHA) components, and the connecting string is a drill string configured to connect the drill bit and the BHA to a surface location during drilling of an earth formation.

### Embodiment 15

The system of embodiment 11, wherein the controller is further configured to calculate an axial force that would be applied to the downhole component by the virtual connecting string, and apply an axial force corresponding to the calculated axial force to the downhole component during the rotating.

### Embodiment 16

The system of embodiment 11, wherein the drilling assembly model describes the connecting string as a torsional spring system having a stiffness and the downhole component as a mass having an inertia.

### Embodiment 17

The system of embodiment 16, wherein the drilling assembly model describes the drilling assembly using the following equation of motion:

I\ddot{φ}+k(φ−Ω₀t)=−T,

wherein “T” is an overall torque applied to the downhole component, “I” is the inertia of the downhole component, “k” is a stiffness of the connecting string, “φ” is an angular deflection of the downhole component, “\ddot{φ}” is an angular acceleration of the downhole component, “t” is time, and “Ω₀” is an angular velocity of the driving device.

### Embodiment 18

The system of embodiment 17, wherein the controller is configured to control the torque motor to apply an amount of torque (T_{Motor}) calculated based on a measurement of the angular deflection taken during the rotating, the amount of torque T_{Motor} calculated based on the following equation:

T_{Motor}=k(φ−Ω₀t)=∫k(\dot{φ}−Ω₀)dt.

### Embodiment 19

The system of embodiment 17, wherein the downhole component has a mass that is less than a total mass of a component assembly expected to be connected to the connecting string, and the controller is configured to control the torque motor to apply an amount of torque (T_{Motor}) calculated based on a measurement of the angular deflection and a measurement of the angular acceleration taken during the rotating, the amount of torque T_{Motor} calculated based on the following equation:

T_{Motor}=(I_{BHA}−I_{BHS})\ddot{φ}+∫k(\dot{φ}−Ω₀)dt,

wherein “I_{BHA}” is an inertia of the component assembly calculated based on the total mass, and “I_{BHS}” is an inertia of the downhole component calculated based on the mass of the downhole component.

### Embodiment 20

The system of embodiment 11, wherein the controller is configured to control the torque motor using a control loop, the control loop including: receiving measurements of a rotational velocity of the downhole component and calculating a target torque value based on the drilling assembly model and the rotational velocity; measuring an amount of torque generated by the torque motor; and comparing the measured torque to the target torque and adjusting the torque motor so that the measured torque is within a selected range of the target torque.

The use of the terms “a” and “an” and “the” and similar referents in the context of describing the invention (especially in the context of the following claims) are to be construed to cover both the singular and the plural, unless otherwise indicated herein or clearly contradicted by context. Further, it should further be noted that the terms “first,” “second,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity).

The teachings of the present disclosure may be used in a variety of well operations. These operations may involve using one or more treatment agents to treat a formation, the fluids resident in a formation, a wellbore, and/or equipment in the wellbore, such as production tubing. The treatment agents may be in the form of liquids, gases, solids, semi-solids, and mixtures thereof. Illustrative treatment agents include, but are not limited to, fracturing fluids, acids, steam, water, brine, anti-corrosion agents, cement, permeability modifiers, drilling muds, emulsifiers, demulsifiers, tracers, flow improvers etc. Illustrative well operations include, but are not limited to, hydraulic fracturing, stimulation, tracer injection, cleaning, acidizing, steam injection, water flooding, cementing, etc.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

1. A method of testing a downhole component, comprising:
selecting a downhole component to be tested, the downhole component configured to be incorporated in a drilling assembly that includes a connecting string configured to connect the downhole component to a surface location;
generating a mathematical drilling assembly model, the drilling assembly model representing the connecting string as a virtual connecting string and describing a behavior of the connecting string in response to rotation of the drilling assembly by a virtual top drive;
disposing the downhole component, by a support structure, at a sample of a formation material, and rotating the downhole component by applying a torque to the downhole component via a torque motor based on the drilling assembly model and a selected rotational rate of the virtual top drive;
during the rotating, receiving real time measurements of an angular velocity of the downhole component;
inputting the angular velocity into the drilling assembly model, and calculating a target torque based on the drilling assembly model, the selected rotational rate of the top drive and the measured angular velocity, the target torque corresponding to an amount of torque that would be applied to the downhole component by the virtual connecting string;
adjusting the applied torque from the torque motor to correspond to the target torque; and
evaluating performance of the downhole component based on the testing.

2. The method of claim 1, wherein the torque motor is configured to apply the applied torque to the downhole component in the absence of a physical structure corresponding to the connecting string.

3. The method of claim 1, wherein the drilling assembly model describes interactions between the virtual connecting string and a borehole during rotation of the virtual connecting string.

4. The method of claim 1, wherein the downhole component is selected from at least one of a drill bit and one or more bottomhole assembly (BHA) components, and the connecting string is a drill string configured to connect the drill bit and the BHA to a surface location during drilling of an earth formation.

5. The method of claim 1, further comprising calculating an axial force that would be applied to the downhole component by the virtual connecting string, and applying an axial force corresponding to the calculated axial force to the downhole component during the rotating.

6. The method of claim 1, wherein the drilling assembly model describes the connecting string as a torsional spring system having a stiffness and the downhole component as a mass having an inertia.

7. The method of claim 6, wherein the drilling assembly model describes the drilling assembly using the following equation of motion:
I\ddot{φ}+k(φ−Ω₀t)=−T,
wherein “T” is an overall torque applied to the downhole component, “I” is the inertia of the downhole component, “k” is a stiffness of the connecting string, “φ” is an angular deflection of the downhole component, “\ddot{φ}” is an angular acceleration of the downhole component, “t” is time, and “Ω₀” is an angular velocity of the driving device.

8. The method of claim 7, wherein controlling includes controlling the torque motor to apply an amount of torque (T_{Motor}) calculated based on a measurement of the angular deflection taken during the rotating, the amount of torque T_{Motor} calculated based on the following equation:
T_{Motor}=k(φ−Ω₀t)=∫k(\dot{φ}−Ω₀)dt.

9. The method of claim 7, wherein the downhole component has a mass that is less than a total mass of a component assembly expected to be connected to the connecting string, and controlling includes controlling the torque motor to apply an amount of torque (T_{Motor}) calculated based on a measurement of the angular deflection and a measurement of the angular acceleration taken during the rotating, the amount of torque T_{Motor} calculated based on the following equation:
T_{Motor}=(I_{BHA}−I_{BHS})\ddot{φ}+∫k(\dot{φ}−Ω₀)dt,
wherein “I_{BHA}” is an inertia of the component assembly calculated based on the total mass, and “I_{BHS}” is an inertia of the downhole component calculated based on the mass of the downhole component.

10. The method of claim 1, wherein applying the torque includes controlling the torque motor using a control loop, the control loop including:
receiving measurements of a rotational velocity of the downhole component and calculating a target torque value based on the drilling assembly model and the rotational velocity;
measuring an amount of torque generated by the torque motor; and
comparing the measured torque to the target torque and adjusting the torque motor so that the measured torque is within a selected range of the target torque.

11. A system for testing a downhole component, comprising:
a support structure configured to dispose a downhole component at a sample of a formation material, the downhole component configured to be incorporated in a drilling assembly that includes a connecting string configured to connect the downhole component to a surface location;
a torque motor operably connected to the downhole component and configured to apply a torque to the downhole component; and
a controller configured to control the torque motor to rotate the downhole component based on a mathematical drilling assembly model, the drilling assembly model representing the connecting string as a virtual connecting string and describing a behavior of the virtual connecting string in response to rotation of the drilling assembly by a virtual top drive, the controller configured to perform:
during the rotating, receiving real time measurements of an angular velocity of the downhole component;
inputting the angular velocity into the drilling assembly model, and calculating a target torque based on the drilling assembly model, the selected rotational rate of the top drive and the measured angular velocity, the target torque corresponding to an amount of torque that would be applied to the downhole component by the virtual connecting string; and
adjusting the applied torque from the torque motor to correspond to the target torque.

12. The system of claim 11, wherein the torque motor is configured to apply the applied torque to the downhole component in the absence of a physical structure corresponding to the connecting string.

13. The system of claim 11, wherein the drilling assembly model describes interactions between the virtual connecting string and a borehole during rotation of the virtual connecting string.

14. The system of claim 11, wherein the downhole component is selected from at least one of a drill bit and one or more bottomhole assembly (BHA) components, and the connecting string is a drill string configured to connect the drill bit and the BHA to a surface location during drilling of an earth formation.

15. The system of claim 11, wherein the controller is further configured to calculate an axial force that would be applied to the downhole component by the virtual connecting string, and apply an axial force corresponding to the calculated axial force to the downhole component during the rotating.

16. The system of claim 11, wherein the drilling assembly model describes the connecting string as a torsional spring system having a stiffness and the downhole component as a mass having an inertia.

17. The system of claim 16, wherein the drilling assembly model describes the drilling assembly using the following equation of motion:
I\ddot{φ}+k(φ−Ω₀t)=−T,
wherein “T” is an overall torque applied to the downhole component, “I” is the inertia of the downhole component, “k” is a stiffness of the connecting string, “φ” is an angular deflection of the downhole component, “\ddot{φ}” is an angular acceleration of the downhole component, “t” is time, and “Ω₀” is an angular velocity of the driving device.

18. The system of claim 17, wherein the controller is configured to control the torque motor to apply an amount of torque (T_{Motor}) calculated based on a measurement of the angular deflection taken during the rotating, the amount of torque T_{Motor} calculated based on the following equation:
T_{Motor}=k(φ−Ω₀t)=∫k(\dot{φ}−Ω₀)dt.

19. The system of claim 17, wherein the downhole component has a mass that is less than a total mass of a component assembly expected to be connected to the connecting string, and the controller is configured to control the torque motor to apply an amount of torque (T_{Motor}) calculated based on a measurement of the angular deflection and a measurement of the angular acceleration taken during the rotating, the amount of torque T_{Motor} calculated based on the following equation:
T_{Motor}=(I_{BHA}−I_{BHS})\ddot{φ}+∫k(\dot{φ}−Ω₀)dt,
wherein “I_{BHA}” is an inertia of the component assembly calculated based on the total mass, and “I_{BHS}” is an inertia of the downhole component calculated based on the mass of the downhole component.

20. The system of claim 11, wherein the controller is configured to control the torque motor using a control loop, the control loop including:
receiving measurements of a rotational velocity of the downhole component and calculating a target torque value based on the drilling assembly model and the rotational velocity;
measuring an amount of torque generated by the torque motor; and
comparing the measured torque to the target torque and adjusting the torque motor so that the measured torque is within a selected range of the target torque.
